(19) United States
(12) Patent Application Publication
(10) Pub. No.: US 2010/0052844 A1
(43) Pub. Date: Mar. 4, 2010

(54) SYSTEM AND METHOD FOR DATA ACQUISITION AND PROCESSING

(76) Inventor: Philip Wesby, Stratford upon Avon (GB)

Correspondence Address: LANDO & ANASTASI, LLP, ONE MAIN STREET, SUITE 1100, CAMBRIDGE, MA, 02142, US

(21) Appl. No.: 12/516,150

(22) PCT Filed: Nov. 21, 2007
(86) PCT No.: PCT/GB2007/004446

§ 371 Date: May 22, 2009

(30) Foreign Application Priority Data
Nov. 23, 2006 (GB) 0623346.4

(51) Int. Cl. G05B 19/00; G06F 15/16; H04W 4/00

(52) U.S. Cl. 340/5.7; 709/206; 707/781; 370/338

(57) ABSTRACT

A system and method for data acquisition and processing is described which can form the basis of new and improved business and consumer services. Encoded datagram images are captured using a mobile phone or PDA or fixed line device and processed relative to a stored encoded profile such that the result of the processing can be used to access services remotely by way of a fixed or network connection and or be used to generate encoded local broadcast signals such as those sent by Bluetooth or Infra Red or WLAN or WIMAX or wireless USB and the like. In this way the capturing device becomes an intelligent service access gatekeeper such that data can be differentially extracted from visible images and used to generate encoded signals according to differential service access privileges which can be used for authenticating and granting building access, operating car park barriers, providing additional security for ATM cash point transactions, operating machinery in diverse applications and the like.

### BACKGROUND OF THE INVENTION

The current invention relates to a system and method for data acquisition and processing.

In particular, the invention relates to a system and method for capturing and or processing a stored or received encoded datagram or pixelated image and or barcode in accordance with a pre-programmed profile for the purpose of generating a dataset.

More particularly, the invention relates to a system and method for capturing and or processing stored or received datagram images using a device such as a mobile phone or PDA or laptop or fixed line device in relation to stored or received data, such as a subscriber profile which comprises differential service access rights, for the purpose of locally activating services. The resulting dataset which is created from processing the received or captured datagram image in relation to the pre-programmed or received subscriber profile is then used to encode a local transmission from the processing device which is received locally to activate machinery such as a car park barrier or door or to provide an enabling key to permit service access. The local encoded transmission may comprise a Bluetooth or Infra Red or WIMAX or wireless USB or WLAN transmission.

This patent application extends the invention of an earlier patent application United Kingdom Patent Application 0619761.0 by the same applicant entitled System and Method for Data Acquisition and Processing having priority date Oct. 6, 2006. In this patent application is taught the method of using datagrams and combining these with user profiles stored within the data capture device, such as a mobile phone or PDA, to create a range of differentiated services.

The current invention can be considered as key inventive extensions of this technology towards the use of the encoded datagram capturing or receiving device—the wireless or fixed line terminal—as a local service enabling terminal. The use of this invention can be further extended to create differential programming algorithms for local short range wireless programming based upon the same captured or received datagram image where the said programming algorithms are computed in accordance with the user ID and specific service access privileges.

Today, mobile network operators are seeking business solutions and technologies which exploit the untapped potential of the mobile phone or PDA or wireless laptop in order to render it as the intelligent device for desirable consumer and business oriented transaction services. The mobile phone is becoming the essential primary and central communications device which is capable of capturing images using camera technology as well as receiving emails. The increasing resolution of camera technology is also making the transmission of image data across the network more acceptable.

Nevertheless, many challenges are facing the mobile network operators as consumers seek data-rich and focussed information services and progressively view the mobile operators as managed high-capacity bit pipes offering multi-bearer (GSM, GPRS, 3G, WLAN, WIMAX et al) access networks. Even the search engine companies themselves are offering relatively few solutions which can be offered by way of the mobile phone to reduce churn and increase subscriber loyalty. Current initiatives merely involve directing adverts to Internet web surfers based upon their history of surfing. A business model based upon generally random wanderings through the internet faces many challenges.

The mobile phone comprises several key technical components which are not successfully exploited to their full. The hi-resolution digital camera may be able to capture photographs, but the average wireless subscriber is still unwilling to transmit these images to family and friends over the network because of the preconceived high costs of the data transmission. Often these preconceived high costs are misconceptions but they represent a real barrier to the use of the network as an image or MMS data carrier, for which networks have been planned to high capacity for. The same argument is relevant to GPRS data transmission in general which is also not fully exploited to its intended capacity.

Clearly, there is a need for a technology and business case which maximises the use of networks for data transmission. This business case must also address the preconception of the cost of transmitting data through the use of a technology which delivers a highly profitable third party service so effectively that the third party will pay for the use of the mobile and fixed line data network.

In the area of payment transactions, credit cards comprise legislated authorisation and authentication protocols which the mobile phone may not replace. Nevertheless, if the mobile phone is considered as the primary device through which payment transactions may be effected, the existing payment protocols can be implemented and further enhanced by capabilities that the mobile phone already possesses and thereby reduce the need for a credit card. The credit card itself makes use of a magnetic strip and a 4-digit PIN number for accessing funds or for effecting payments. Clearly a technology which can improve the security of credit transaction payments by adding additional layers of security renders such systems less open to fraud. In this context the mobile phone offers improved authentication based upon the subscriber identity SIM and networked link to a remote subscriber profile held by the credit card company.

In the area of transaction services which permit access to buildings and car parks through automated doors, the mobile phone comprises the capability to add a subscriber-specific or employee-specific authentication, which itself may be used to grant access to the said services using a the mobile phone's capability to generate short range transmissions such as Bluetooth and in some instances IR etc. These local broadcast capabilities of the mobile phone are generally under-exploited.

Further to the limitations of existing methods used for enhancing security and local service access and local data validation, and so far as is known, no optimum system and method for data acquisition and processing is presently available which is directed towards the specific needs of this problem area as outlined.

### OBJECTS OF THE INVENTION

Accordingly, it is an object of the present invention to provide an improved system and method for data acquisition and processing which serves to use a wireless or fixed line device to capture or receive or have pre-programmed in its memory specific encoded information, and process this Information with a pre-stored or received user profile comprising certain attributes and generate a data set which can then be used to gain access to one or more services.

It is a further object of one embodiment of the present invention to provide a system and method for data acquisition and processing which makes use of a wireless or fixed line device to capture or receive visual information using an associated digital camera and process this information using a pre-stored or received user profile which comprises specific service access rights and then generate a dataset which can be used to gain access to one or more services and or control equipment.

It is a further object of one embodiment of the present invention to provide a system and method for data acquisition and processing in which a communication device with wireless or fixed line network access can receive or can capture, by way of an associated camera, a data-containing image and can extract data from the said image according to a data extraction algorithm wherein the data extracted is determined by a pre-programmed or received data extraction user profile and wherein a dataset is generated which can be used to encode and transmit local wireless transmissions such as by Bluetooth, Infra Red, WLAN, WIMAX, and wireless USB and the like.

It is a further object of one embodiment of the present invention to provide a system and method for data acquisition and processing in which a communication device can generate or receive a dataset which is capable of encoding a local transmission from the said communication device and thereby communicate with a local asset which has the capability of receiving and processing the encoded transmission for the purpose of activating a service from the said asset.

It is a further object of one embodiment of the present invention to provide a system and method for data acquisition and processing wherein an encoded image containing data, or a datagram, is displayed to a camera device with processing function which has the capability to extract data from the image and process it using a pre-programmed dataset stored in its memory in order to compute a dataset key (DKEY) for the purpose of encoding a local transmission to be sent from the said camera device. This local transmission is used to communicate with a wireless device, such as a wireless transponder, associated with the datagram wherein the said wireless device responds with a specific encoded response (f*DKEY) which is further received by the camera device. In this way identification of a specific person or asset can be improved by determining that the datagram is associated with a specific person or asset who or which carries the associated authentic wireless response device wherein upon receipt of the correct sought response (f*DKEY) the camera device then grants access to associated local or remote services or if an incorrect response is received no access is granted and or an alarm is generated.

It is a further object of one embodiment of the present invention to provide a system and method for data acquisition and processing which makes use of capturing data from an encoded image, or datagram, using a camera device such as a mobile phone or PDA comprising a digital camera, wherein the datagram is printed on the surface of a wireless transponder device which generates an encoded response (f*DKEY) in response to receiving a signal (DKEY) and wherein the encoded signal (DKEY) may be generated from a device which processes data captured from the datagram image in accordance with a predetermined subscriber profile or access key.

It is a further object of one embodiment of the present invention to provide a system and method for data acquisition and processing which makes use of capturing data from an encoded image, or datagram, which may be black and white or in colour and or which may comprise a holographic image and or which may be an active light transmitting element comprising a filter and wherein the light transmitting element transmits electromagnetic energy in different parts of the electromagnetic spectrum such as in the infra red or ultraviolet ranges.

It is a further object of one embodiment of the present invention to provide a system and method for data acquisition and processing which makes use of capturing and processing data from an encoded image, or datagram, in relation to a stored dataset and thereby generate short range encoded signals for access to local services such as obtaining products from vending machines, or to open car park barriers and to unlock doors and the like.

It is a further object of one embodiment of the present invention to provide a system and method for data acquisition and processing wherein mobile phones and PDAs are adapted to become short range wireless programming devices having differential capability based upon the same captured or received datagram image where the programming algorithms generated are computed in accordance with the user ID and specific service access privileges.

It is a further object of one embodiment of the present invention to provide a system and method for data acquisition and processing which is highly suited to creating and developing innovative information based services which can be directly linked to retailers and finance credit organisations.

It is a further object of one embodiment of the present invention to provide a system and method for data acquisition and processing which is highly suited to creating and developing innovative information based services which converge through the mobile phone or PDA and thereby put the purchase transaction information into the hand of the mobile phone consumer subscriber desiring to make a purchase of a specific product.

It is a further object of one embodiment of the present invention to provide a system and method for data acquisition and processing which is highly suited to creating and developing innovative transaction based services which are based upon the use of the mobile phone digital camera and the capability of the mobile phone to encode and transmit short range signals.

It is a further object of one embodiment of the present invention to provide a system and method for data acquisition and processing which is highly suited to creating and developing innovative transaction based services such as for making withdrawals from ATM cash point machines which incorporate the capture and processing of datagram images and the subsequent transmission of a local signal by Bluetooth or infra red to enable the transaction to occur wherein the datagram may comprise an image generated on the screen of the ATM machine and which may be encoded according to specific data associated with the person making the cash transaction request.

It is a further object of one embodiment of the present invention to provide a system and method for data acquisition and processing which is highly suited to creating and developing innovative transaction based services in which a first datagram image generated on a screen of a transaction device is captured and processed to generate a dataset in the capturing device which may be used to encode a short range transmission which in turn is received by the said transaction device which subsequently generates a second datagram image based upon the received transmission which is then captured and processed. This offers the possibility for multiple levels of security to validate and authenticate a consumer's rights to access a service or transaction.

It is a further object of one embodiment of the present invention to provide a system and method for data acquisition and processing which is highly suited to creating and developing innovative transaction based services such as for making withdrawals from ATM cash point machines in which the consumer captures a first datagram image from a screen or from a printed image and uses specific data within the capturing device to encode and communicate a short range response, or to compute an access code which the consumer enters into the ATM machine, which in turn generates a second datagram image which is subsequently processed and used to authenticate and or authorise a cash withdrawal transaction.

It is a further object of one embodiment of the present invention to provide a system and method for data acquisition and processing which is highly suited to authenticating documents such as bank notes wherein the document or bank note may be printed with one or more encoded datagram images and wherein the subsequent capturing of the said one or more datagram images and extraction of data from them may be used to determine the authenticity of the document or banknote in relation to other information printed upon the document or bank note and or information stored upon a microchip associated with or contained upon or within the document or banknote.

It is a further object of one embodiment of the present invention to provide a system and method for data acquisition and processing which is highly suited to public transport payment applications whereby a traveller captures a datagram image displayed in a public transport vehicle using a mobile phone or PDA device and the processing of the data extracted from the datagram with pre-programmed data, or a user profile, generates a dataset which may encode a local Bluetooth transmission which is received by a device which confirms that the traveller has made a valid travel payment, or will be charged, or that it has been confirmed that the traveller possesses a valid season ticket for travel.

It is a further object of one embodiment of the present invention to provide a system and method for data acquisition and processing which is highly suited to a medical application where confidential patient information may be displayed at the foot of a patient's bed in a hospital such that encoded datagram images may be used to contain private personal data and only be capable of being read by a doctor holding the right equipment bearing the decoding algorithm.

It is a further object of one embodiment of the present invention to provide a system and method for data acquisition and processing which is highly suited to a medical application in which the data acquisition device captures a data-encoded image or datagram and displays information on its own screen which may be modified by entering data from a keyboard or receiving data from another source, either by fixed line or wireless transmission, wherein a new datagram may be computed and either sent to a printer for printing and to be attached to and to update a patient's daily status report, or transmitted to a data centre for updating patients' records, or sent to a screen device associated with the patient's location.

It is a further object of one embodiment of the present invention to provide a system and method for data acquisition and processing which is highly suited to a general status report updating applications wherein encoded data is captured using a data acquisition device wherein the data may be encoded visual data such as a photograph or a graphic image, on a paper or film medium or on a screen, or it may be data transmitting outside the visual spectrum, wherein the received data is decoded and displayed on a suitable computer terminal or PDA or data-input device and updated and wherein a subsequent datagram or encoded data dataset is then generated for printing or transmission so that the information is now up to date.

Other objects and advantages of this invention will become apparent from the description to follow when read in conjunction with the accompanying drawings.

### BRIEF SUMMARY OF THE INVENTION

Certain of the foregoing and related objects are readily-attained according to the present invention by the provision of a novel system and method for data acquisition and processing which can form the basis of new and exciting business and consumer services which involve the use of the mobile phone or PDA as a local transmitter which in response to capturing and processing visual data the device is enabled to generate a dataset to encode a local transmission for the purpose of activating transaction-based services.

In essence the invention proposes some ways to transform wireless devices such as mobile phones, PDAs and laptops as devices which can activate and access local services and or systems.

In particular the invention teaches a way to gain access to local services by processing visual data in accordance with a stored or received dataset and to encode a Bluetooth or infra-red or wireless USB or WLAN transmission as a direct result of processing the said extracted visual data with the said dataset wherein the transmission is received by a device capable of enabling the service.

The invention addresses the requirement for a mobile phone or PDA needing to communicate over a telecommunications cellular network for service access by exploiting the capability of the mobile phone to process visual information and extract data from it to encode a local transmission which can operate equipment such as a car park barrier, effect a vending machine purchase, or unlock a door. The same invention may be implemented in several alternative ways such as to provide multiple levels of security when applied to an ATM cash point machine such that data extracted from an on-screen datagram is used to encode a transmission which may generate an alternative datagram which when captured and processed generates an alternative dataset which subsequently encodes a local and or a cellular network data communication transmission.

In separate embodiments, the invention can be applied to authorise travel on public transport, to authenticate documents such as printed bank notes, to access and read and update patient records, and to access and read and update data-encoded images in general The invention is also suitable for encoding and printing destination labels and also for lottery tickets based upon a data-encoded image where each ticket is separately encoded according to the lottery number contained therein.

Other objects and features of the present invention will become apparent from the following detailed description considered in connection with the accompanying drawings, which disclose several key embodiments of the invention. It is to be understood, however, that the drawings are designed for the purpose of illustration only and that the particular applications are given by way of example only and do not limit the scope of the invention.

### BRIEF DESCRIPTION OF THE DRAWINGS

FIG. 1 illustrates a schematic showing how local transaction-based services can be activated according to one embodiment of the invention.

FIG. 2 illustrates a schematic showing an alternative application of local processing of a data-encoded image.

FIG. 3 illustrates a schematic showing how additional services may be requested to update the service access profile.

### DESCRIPTION OF A PREFERRED EMBODIMENT

Reference will now be made in detail to some specific embodiments of the invention including the best modes contemplated by the inventor for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as defined by the appended claims. The following description makes full reference to the detailed features as outlined in the objects of the invention.

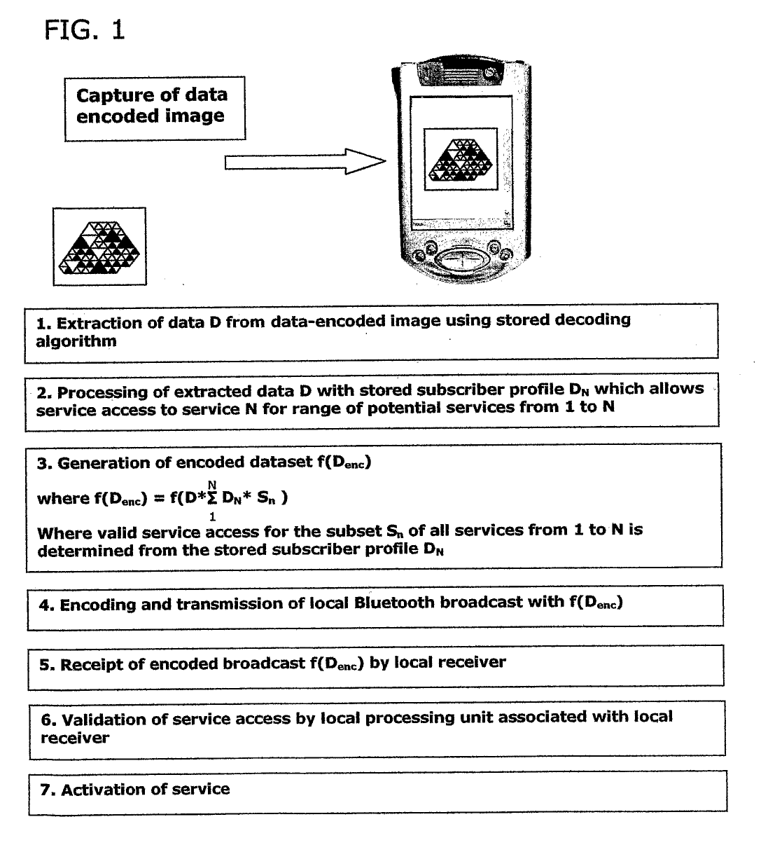

Referring now in detail to the drawings and in particular FIG. 1 thereof, therein illustrated is a schematic of one example showing how locally based services may be activated according to the current invention.

A wireless device such as a PDA (102) comprising a digital camera captures a data-encoded image which contains data relating to a service activation. The data-encoded image may be displayed upon the capturing device as shown. The user may then activate a data extraction algorithm or this algorithm is activated automatically by the datagram acquisition process.

As indicated in the sequence of 7 actions, the following processes then occur. Firstly, (1) the data extraction algorithm extracts a dataset (D) from the data-encoded image.

Next, (2) the extracted dataset is then processed in accordance with a stored subscriber profile D_{N}. This subscriber profile may be pre-programmed into the handset and stored in a memory chip as firmware. Alternatively, this profile may be received over the air interface as an MMS or data message and stored in accordance with a service profile update received by the subscriber.

As a further alternative, in an alternative embodiment where real time, up-to-date knowledge of a subscriber's current service access rights are needed such as in security applications, the subscriber profile may be requested in real time from a data centre connected with the cellular network. In each instance, the received and extracted data is processed in accordance with the subscriber's service access subscriber profile.

For example, this access may relate to a range of services from 1 to N where N is the number of services available.

Next (3) an encoded dataset is generated f(D_{enc}) which will be a function of the data D extracted from the image which is correlated with the number of available services from 1 to N and the subset of services Sₙ to which the subscriber has rights of access.

(4) The encoded dataset f(D_{enc}) is then used to encode and transmit a local Bluetooth broadcast. This broadcast is then (5) received by a local receiver and (6) validated by a processing unit associated with the local receiver. If the processed received Bluetooth transmission comprises authentic service access data, the local processing unit associated with the local service then (7) activates the service.

There are many applications which will benefit from this direct local service activation capability. In the car park barrier instance where a driver may wish to authenticate his identity to gain access to the car park, particularly in the rain and dark where cellular network coverage may be poor, local service activation enables the use of the mobile phone or PDA to activate a service without needing to necessarily make a connection with the cellular network. This solution is also rapid and does not necessarily require confirmation from a remote data centre.

In certain security applications, as mentioned earlier, such real time validation may be required.

In other instances, the invention may be applied to provide building zone access to company personnel, and often inside buildings where network coverage is very poor or unavailable due to Faraday shielding effects. Employees make use of their mobile phone as the primary device and the incorporation of the mobile phone as a local service activation device correspondingly enables data capture using the mobile phone, processing according to access rights and activation of building automated doors using a local service activation capability.

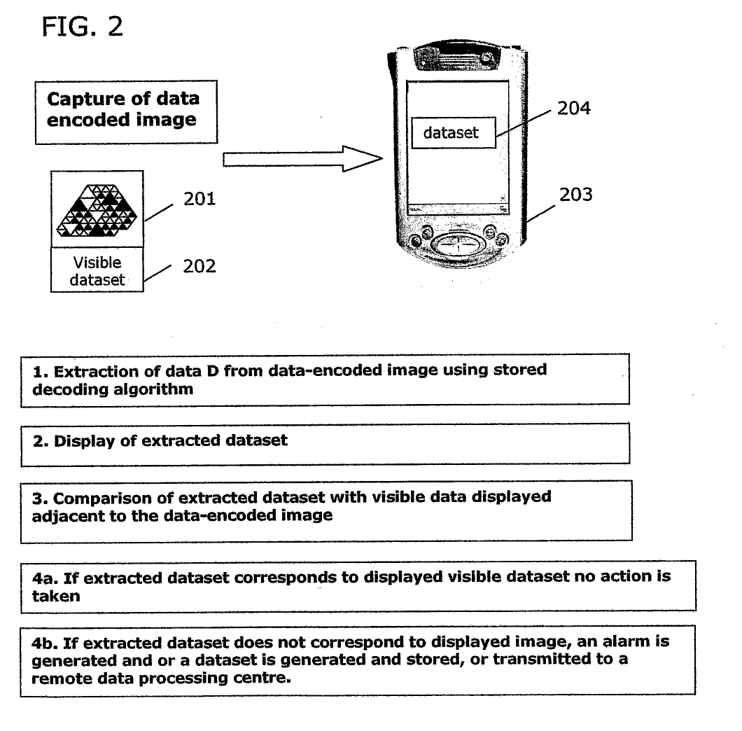

Now with reference to FIG. 2 is shown an alternative application of the local processing of a data-encoded image. A wireless device such as a mobile phone or laptop or PDA (203) as shown captures the data-encoded image (201) and it is processed using a stored decoding algorithm (1). The decoded dataset from the data-encoded image is then (2) displayed on a screen (204). Associated with the data-encoded image is a visible dataset (202). The displayed dataset (204) which has been decoded from the captured image is then compared (3) with the visible dataset (202) which may be located on a structure or device adjacent to the data-encoded image. If the extracted dataset corresponds (4a) to the displayed dataset (202) no action is taken. If the extracted dataset does not correspond (4b) to the displayed image, an alarm is generated and or the same or a different dataset is generated and stored and or transmitted to a remote data processing centre.

This application may be suitable for validating the authenticity of documents or tickets or licenses or other important documents. A similar process may be used to validate the authenticity of bank notes as they pass through a cash-dispensing system or the like.

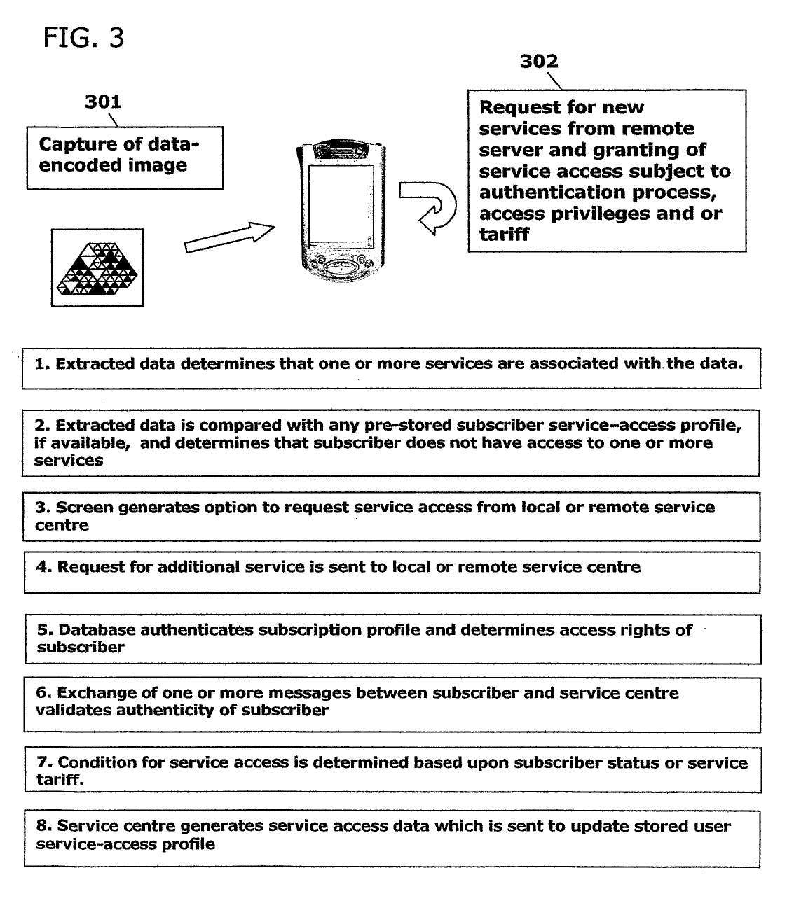

Now with reference to FIG. 3 is shown a sequence of actions which enables a subscriber to update his or her service access profile.

First a PDA or mobile phone captures (301) a data-encoded image. Now with reference to the sequence of steps from 1 to 7, the following actions ensue.

Data is extracted (1) from the data-encoded image and determines that one or more services are associated with the data. This could be done by encoding a recognisable icon or code sequence which determines that specific subscriber-accessible or corporate employee accessible services are available.

The extracted data is then compared (2) with any pre-stored subscriber service-access profile, if one is actually available, and determines whether the subscriber does not have access to any of the available services.

If it is determined that services exist to which the subscriber does not currently have access, a screen display is generated (3) which gives the subscriber the option to request service access from a local or remote service centre.

The request for one or more additional services, currently not available according to the existing user service access profile, is then sent (4) to a local or remote service centre.

The service centre authenticates (5) the subscription profile and determines the access rights of the subscriber. This is further authenticated by exchanging (6) one or more messages between the subscriber and the service centre which validates that the true subscriber is requesting service access.

Following validation, the condition for service access is determined (7) based upon subscriber status or service tariff. In other words, if the subscriber is requesting access to corporate services, then it is determined that the subscriber is a valid and current employee with the corporate. Alternatively, if the subscriber is requesting paid services, then the subscriber may be asked to confirm that he or she agrees to pay a particular tariff for access to the services.

The service centre then generates a dataset which represents a modification to the stored user service-access profile and either transmit this modification back to the subscriber to enable access to the sought one or more services, or a new total service access profile is sent to the subscriber to replace the existing service access profile.

The same method as described with reference to FIG. 3 may be used to cancel the complete service access profile in the instance that a request is made to access services by an unauthorised person requesting service access.

This has particular application in the instance when the mobile phone or PDA in question is reported stolen, or when a person is no longer an employee of a particular company and access to corporate services are to be withdrawn.

It is important to consider the roll out or implementation of this invention in relation to the existing capabilities and functionality of mobile phones and PDAs. The invention is best implemented using a downloadable software application program such as a Java Applet which will modify the user interface and store and update and reference the stored user profile.

In this first phase, a digital photo captured by the phone camera is sent by MMS to an IP address or mobile phone number which is associated with a network element such as data processing centre which will receive and process the captured MMS image. The digital image received by the network element will be processed for its data content and a dataset will be generated and compared to pre-stored datasets and data will be sent back to the mobile phone which sent the MMS.

Sufficient redundancy exists within the encoded image that the entire datagram image can be reconstructed from a blurred or incomplete image. In this way, the success of the method and its use as a service-enabling technology is greatly extended and not dependent upon perfect in-focus capture of 100% of the encoded image for it to work. In particular, the design of the image encoding is chosen to address this issue of data extraction from blurred images. Different levels of processing to extract data from a blurred or incomplete image may be required dependent upon the application such as where the encoded image to be captured is large or small.

From the device perspective, there are many ways to implement the functionality of the invention upon existing mobile phones or PDAs or wireless-enabled laptops etc. The requirements are that the wireless device has a digital camera and can transmit data and or MMS messages.

From a consumer perspective, the subscriber may have initially registered for the service capability (paying an opt-in fee) and will register an email address etc. Subscribers may then receive an invite to the service and only need REPLY to receive an application program such as a Java applet. The Java applet self-loads and links to saved IP addresses or phone numbers in the phone's address book. From a business perspective, an employee may be given a mobile phone or PDA which already has on it specified user-profile service access privileges and links to a corporate email account.

It is anticipated that different service privileges may be associated with different IP addresses or destination fixed or mobile phone numbers. In this way the control of service access privileges may be distributed among different service companies.

While the present invention has been described herein with reference to particular embodiments thereof, a latitude of modification, various changes, and substitutions are intended in the present invention. In some instances, features of the invention can be employed without a corresponding use of other features, without departing from the scope of the invention as set forth. Therefore, many modifications may be made to adapt a particular configuration or method disclosed, without departing from the essential scope and spirit of the present invention. It is intended that the invention not be limited to the particular embodiments disclosed, but that the invention will include all embodiments and equivalents falling within the scope of the claims.

1. A secure wireless service activation or control equipment access system comprising a user wireless data acquisition device comprising:
a digital camera further comprising one of a pre-programmed decoding software, encoding software, formatting software, a user access profile, and a process for capturing encoded datagram images and for making a dataset for encoding a local transmission according to said user access profile and for processing said dataset in accordance with said stored user access profile (DN);
a wireless transponder device that is physically associated with said encoded datagram images further containing data (D) relating to a service activation or control equipment access,
wherein said wireless transponder device further comprising means for directly allowing said service activation or control equipment access, by exchanging at least one of short range encoded signal messages between said user wireless data acquisition device and said wireless transponder device,
a remote server associated with said wireless data acquisition device for managing the access rights of a user further comprising a database of the profile and access rights linked to each users,
wherein access is granted to said requested service or said control equipment is activated either following exchange of messages between the device and the transponders, or wherein access is granted following exchange of messages between the device and the remote server and subsequent exchange of messages between the device and the transponder.

2. The secure wireless service activation or control equipment access system as disclosed in claim 1, wherein said user being one of a consumer, or subscriber, or a company employee having access rights to said service activation or control equipment,
wherein said user provides data to register for the service and downloads one of an application program or a Java applet,
wherein said program or Java applet is self-loading and saving one of IP addresses or phone numbers in the memory of said wireless data acquisition device, or wherein said user being an employee is given a pre-programmed wireless devices,
wherein said device contains a specified user-profile giving service access privileges according to the job function of said user.

3. The secure wireless service activation or control equipment access system as disclosed in claim 1, wherein said wireless data acquisition device is one of a PDA or a mobile phone or a multimedia computer or a laptop and
said wireless transponder device transmission with said wireless data acquisition device is via one of Bluetooth or Infra Red or WLAN or WIMAX or wireless USB, or a telecommunications cellular network transmission.

4. The secure wireless service activation or control equipment access system as disclosed in claim 1, wherein said datagram is one of printed on the surface of or nearby said wireless transponder device, or displayed on a screen or comprising redundancy for allowing said entire datagram to be reconstructed from one of a blurred or incomplete image.

5. The secure wireless service activation or control equipment access system as disclosed in claim 1, wherein said remote server comprising a message transaction server further comprising a data processing centre hosting said plurality of profiles of said plurality of subscribers wherein each of said subscriber having access to one of a plurality of network service activation, or control equipment access according to the profile of said user.

6. The secure wireless service activation or control equipment access system as disclosed in claim 1, wherein said service or control equipment further comprises one of access to product information or operation of a car park barrier or effecting a vending machine purchase or unlocking a door of a building or vehicle or activation of an ATM cash point machine or confirmation of travel payment or a hospital patient record inspection system.

7. The secure wireless service activation or control equipment access system as disclosed in claim 6, wherein said service further comprises a secure transaction for an ATM cash point machine comprising one of on the screen of or shown adjacent to the screen of said ATM cash point machine said encoded datagram image,
wherein said user making a withdrawal from said ATM cash point machine said user wireless data acquisition device captures and processes said encoded datagram image with said profile data and further transmits new encoded data to said wireless transponder device by one of Bluetooth or infra red or other radio transmission for securely authenticating and allowing said user to execute said withdrawal or said authentication incorporates an access code entered by said user through the keypad of said ATM cash point machine or said authentication involving an exchange of messages between the said device and one of the remote server or an exchange of user input data.

8. The secure wireless service activation or control equipment access system according to claim 5, wherein said encoded datagram image is one of printed or embossed or perforated or cut into the surface of one of tickets or licenses or documents or credit cards or bank notes or security documents or product packaging.

9. A secure wireless service activation or control equipment access method comprising a user wireless data acquisition device comprising a digital camera further comprising one of a pre-programmed decoding software or encoding software or formatting software and a user access profile, comprising the steps of:
(1) capturing an encoded datagram image and computing a dataset for encoding a local transmission according to said user access profile; and
(2) processing said dataset in accordance with said stored user access profile (DN), said method comprising the steps of:
(3) generating an encoded dataset f(Denc),
wherein said encoded dataset f(Denc) being a function of the data (D) extracted from said encoded datagram image correlated with the number of available services or control equipment access rights from 1 to N and the subset of services (Sn) said user having rights of access to; and
(4) encoding and transmitting said encoded dataset f(Denc) to a wireless transponder wherein said transmission is via one of Bluetooth or Infra Red or WLAN or WIMAX or wireless USB, or a telecommunications cellular network.

10. The secure wireless service activation or control equipment access method according to claim 9, further comprising the steps of:
receiving said encoded dataset f(Denc) by said wireless transponder;
validating said encoded dataset f(Denc) by a processing unit associated with wireless transponder, comparing the encoded dataset f(Denc) with local decrypted data; and
granting and activating said service or equipment access when said encoded dataset f(Denc) comprising authenticated data.

11. The secure wireless service activation or control equipment access method according to claim 9, wherein said user profile is one of pre-programmed into said wireless data acquisition device and stored in a memory chip as firmware,
or wherein said profile is received over the air interface as one of a multimedia message service (MMS) or data message or via a data packet stream and stored in accordance with a service profile update received by said user,
or wherein said user profile is requested in real time from a remote data centre.

12. A secure wireless service activation or control equipment access method comprising a user wireless data acquisition device comprising a digital camera further comprising one of a pre-programmed decoding software or encoding software or formatting software and a user access profile, comprising the steps of:
(1) capturing an encoded datagram image and computing a dataset for encoding a local transmission according to said user access profile; and
(2) processing said dataset in accordance with said stored user access profile (DN), said method comprising the steps of:
(3) generating an encoded dataset f(Denc) wherein said encoded dataset f(Denc) is a function of the data (D) extracted from said encoded datagram image correlated with the number of available services or control equipment access rights from 1 to N and the subset of services Sn said user having rights of access to; and
(4) displaying a visible dataset on said wireless data acquisition device screen of said decoded dataset from said data encoded dataset f(Denc) associated with said data-encoded image.

13. The secure wireless service activation or control equipment access method according to claim 12, further comprising the steps of:
comparing said decoded displayed dataset with said visible dataset wherein said visible dataset is located on one of a structure or device adjacent to said data-encoded images; and
encoding and transmitting said decoded dataset and said visible dataset to a remote server for authentication.

14. The secure wireless service activation or control equipment access method according to claim 13, further comprising the steps of:
taking action if said decoded dataset and said displayed dataset do correspond with each other; and
generating an alarm if said extracted dataset and said displayed dataset do not correspond,
wherein said alarm is one of visible or audible or a message transmitted to a remote data processing centre,
wherein said message is one of an MMS message or a data message or a photograph of said user requesting activation of equipment or access to service taken from an associated camera device in the vicinity of the said datagram image.

15. The secure wireless service activation or control equipment access method according to claim 13, further comprising the steps of:
taking action if said decoded dataset and said displayed dataset do correspond with each other; and
generating an alarm if said extracted dataset and said displayed dataset do not correspond,
wherein said alarm is one of visible or audible or a message transmitted to a remote data processing centre, wherein said message is one of an MMS message or a data message or a photograph of said user requesting activation of equipment or access to service taken from an associated camera device in the vicinity of the said datagram image.

16. The secure wireless service activation or control equipment access method according to claim 14, wherein said step of generating an alarm further comprises one of canceling said user profile from said user profile database or sending a transmission to the wireless data acquisition device to deactivate the service.

17. The secure wireless service activation or control equipment access method according to claim 15, wherein said encoded datagram image is one of printed or embossed or perforated or cut into the surface of one of tickets or licenses or documents or credit cards or bank notes or security documents or product packaging.
